(19) United States
(12) Patent Application Publication
(10) Pub. No.: US 2008/0182217 A1
(43) Pub. Date: Jul. 31, 2008

(54) HEATING DEVICE, HEATING METHOD AND STORAGE MEDIUM

(75) Inventors: Tetsuo Fukuoka, Koshi-Shi (JP); Takahiro Kitano, Koshi-Shi (JP); Kazuo Terada, Koshi-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo-To (JP)

(21) Appl. No.: 12/020,898

(22) Filed: Jan. 28, 2008

(30) Foreign Application Priority Data
Jan. 31, 2007 (JP) 2007-021355

(51) Int. Cl. F27D 15/02; F27D 3/00

(52) U.S. Cl. 432/1; 432/77

(57) ABSTRACT

A heating device 1 includes a flat heating chamber 3 provided with a side opening. A substrate W is carried in a horizontal position through the side opening into the processing chamber 3, and is subjected to a heating process in the heating chamber 3. the heating chamber 3 is provided with heating plates 34 and 35 respectively provided with heating elements 34a and 35a, and a cooling mechanism 2 for cooling the heating plates 34 and 35. A controller 7 controls the cooling mechanism such that the heating plates 34 and 35 are cooled after the completion of the heating process for heating the substrate W and before a succeeding substrate W is carried into the heating chamber 3, and controls the heating elements 34a and 35a such that the heating plates 34 and 35 are heated at a processing temperature after the succeeding substrate has been carried into the heating chamber 3.

### BACKGROUND OF THE INVENTION

1. Field of the Invention

The present invention relates to a heating device for heating a substrate coated with a film, such as a resist film, a heating method, and a storage medium storing a computer program specifying steps of the heating method.

2. Description of the Related Art

A coating and developing system is used as a resist pattern forming system for forming a resist pattern on a semiconductor wafer or a glass substrate for a LCD (liquid crystal display). The coating and developing system coats a substrate with a resist film, and develops a resist pattern after the substrate has been processed by an exposure process. The coating and developing system is internally provided with a heating device called a baking device. The heating device heats a substrate coated with a resist solution film to vaporize a solvent contained in the resist solution film to form a dry resist film on the substrate and heats the substrate processed by an exposure process before subjecting the substrate to a developing process.

The heating device is required to be able to process a substrate by a heating process in a high intrasurface uniformity. Heating time of a heating process for diffusing an acid in a resist solution processed by an exposure process, namely, postexposure baking process (PEB process) needs to be strictly managed. Therefore, a heating device provided with a special arm having a cooling function is used for such a heating purpose. The heating device provided with the special arm transfers a heated substrate quickly to the special arm to stop the diffusion of the acid (an acid reaction). This heating device removes heat roughly from the substrate therein and hence the number of cooling plates can be reduced. This heating device is used also for hating a substrate coated with a resist solution film.

The heating device of this type needs lifting pins and a lifting mechanism for lifting the lifting pins to transfer a substrate between the special arm and a heating plate, and to ensure a clearance for a transfer operation, which increases the height of the heating device. It is desirable to stack modules in layers to reduce a floor space necessary for installing the coating and developing system. The heating device having a big height places a restriction on the number of modules in a stack. Time needed for transferring a substrate between the special arm and the heating plate is an overhead time, namely, time not directly related with the heating process, causing the reduction of throughput.

To solve such a problem in the conventional heating device, the inventors of the present invention developed a heating device including a heating chamber, a cooling plate disposed in front of the heating chamber, and wires for carrying a semiconductor wafer (hereinafter referred to simply as “wafer”), namely, a substrate, between the cooling plate and the heating chamber. FIG. 14 is a typical cross sectional view of the interior of such a heating device 100. The heating device 100 is internally provided with a heating chamber 101 having the shape of a flat box provided with an opening 101a in its side wall, and a cooling plate 105 disposed in front of the heating chamber 101. The cooling plate 105 cools a wafer W processed by a heating process.

A wafer W carried into the heating device 100 is placed on the cooling plate 105 by an external wafer carrying mechanism as shown in FIG. 14A. The cooling plate 105 is provided with, for example, two grooves 105a extending in a direction perpendicular to a carrying direction in which the wafer W is carried. Two wires 104A and 104B are extended in the grooves 105a, respectively. The cooling plate 105 is lowered to transfer the wafer W to the wires 104A and 104B. A moving mechanism, not shown, interlocked with a wire-holding part holding the wires 104A and 104B moves the wires 104A and 104B to carry the wafer W through the opening 101a into the heating chamber 101.

The interior of the heating chamber 101 is heated beforehand by heating plates 102A and 102B disposed on and beneath the heating chamber 101, respectively. As shown in FIG. 14B, a hot gas is blown by a gas blowing device 103a, and the hot gas is sucked by an exhaust device 103b to produce a unidirectional flow of the hot gas. Thus the wafer W not placed in contact with the heating plate is heated. The wafer W thus heated is moved in the reverse direction toward the cooling plate 105, and is placed on the cooling plate 105 to cool the wafer W is cooled rapidly to stop changes in a resist film formed on the wafer W. The wafer W thus cooled is sent out from the heating device 100.

The heating device 100 of this type developed by the inventors of the present invention subjects the wafer W supported on the wires 104A and 104B to the heating process. Therefore, any operations like those needed by the conventional heating device for transferring a wafer W between the special arm and the heating plate are not necessary. Consequently, overhead time can be curtailed to prevent the reduction of throughput.

In this heating device 100, the wafer W is carried horizontally in a carrying direction into the heating chamber 101 heated beforehand. Therefore, there is a time difference in the range of about 1 to about 3 s between the time the front end, with respect to the carrying direction, of the wafer W enters the heating chamber 101 and the time the rear end, with respect to the carrying direction, of the wafer W enters the heating chamber 101. Consequently, there is an initial temperature distribution in the surface of the wafer W immediately after the wafer W has been completely inserted into the heating chamber 101, in which a temperature difference between the front and the rear end of the surface of the wafer W is, for example, about 3° C.

Consequently, front and rear end, with respect to a carrying direction in which the wafer w is carried into the heating chamber 101, of the wafer W are heated at greatly different temperatures, respectively, as shown in FIG. 7A, and differ in the degree of diffusion of the acid. Such a mode of heating the wafer W causes heating the wafer W in irregular intrasurface uniformity and forming a film having irregular thickness.

Heating plates, similar to that in an embodiment of the present invention, mentioned in Paragraphs 0007 to 0009 of JP-A 2001-308081 (Cited reference 1), and in Paragraphs 0005 and 0031 of JP-A 2001-52985 (Cited reference 2) have a back surface in which a cooling medium is passed for force cooling. Techniques disclosed in Cited references 1 and 2 are intended for improving throughput and for preventing the stress cracking of a heating plate. Therefore, a problem of the front and the rear end of a substrate carried into the heating chamber being differently heated cannot be solved even if one of the heating plates mentioned in Cited references 1 and 2 is placed in the heating chamber.

### SUMMARY OF THE INVENTION

The present invention has been made in view of such circumstances and it is therefore an object of the present invention to provide a heating device capable of reducing temperature difference in a surface of a substrate when the substrate is carried into the heating chamber thereof, and of uniformly heating the substrate, a heating method, and a storage medium storing a program specifying the steps of the heating method.

A heating device according to the present invention includes: a heating chamber contained in a processing vessel to process a substrate horizontally carried therein through a side opening by a heating process; heating plates disposed so as to be opposite to the substrate carried into the heating chamber; heating means for heating the heating plates; cooling means for cooling the heating plates; carrying means, for carrying the substrate between a waiting position adjacent to the side opening of the heating chamber, and a heating position corresponding to the heating plates, placed in the processing vessel; and a control means for controlling the cooling means so as to lower the temperatures of the heating plates after the heating process for heating the substrate has been completed and before a succeeding substrate is carried into the heating chamber, and controlling the heating means so as to raise the respective temperatures of the heating plates to a processing temperature for the heating process after the succeeding substrate has been carried into the heating chamber.

Preferably, the control means controls the heating means such that the heating plates are heated at a temperature higher than the processing temperature after the substrate has been carried into the heating chamber, and then the heating plates are maintained at the processing temperature. Preferably, the heating plates are made of, for example, carbon, and the carrying means are a plurality of wires. A substrate may be subjected to the heating process at a position at a height in the heating position to which the substrate has been carried by the carrying means.

A heating method according to the present invention includes: a carrying step of horizontally carrying a substrate through a side opening of a heating chamber formed in a processing vessel into the heating chamber; a heating step of heating the substrate carried into the heating chamber by heating plates; a temperature lowering step of lowering the temperature of the heating plates after the heating process for processing the substrate has been completed and before a succeeding substrate is carried into the heating chamber; and a temperature raising step of raising the temperature of the heating plates to a processing temperature after the succeeding substrate has been carried into the heating chamber.

Desirably, the heating method further includes, between the carrying step and the heating step, a temperature controlling step of heating the heating plates to a temperature higher than the processing temperature, and then maintaining the heating plates at the processing temperature. Preferably the heating step of heating the substrate is executed with the substrate held at a position at a height in the heating chamber to which the substrate has been carried.

A storage medium according to the present invention stores a computer program to be executed by a heating device contained in a processing vessel, and including a heating chamber provided with a side opening through which a substrate is carried into the heating chamber, and heating plates for heating the substrate from below the substrate; wherein the computer program specifies the steps of one of the foregoing heating methods.

According to the present invention, the interior of the heating chamber is cooled to a temperature lower than the processing temperature before a substrate is carried through the side opening of the flat heating chamber into the heating chamber. Therefore, the temperature difference between a front and a rear end part immediately after the substrate has been carried into the heating chamber can be reduced. Consequently, the substrate can be heated in an intrasurface uniformity by, for example, the heating process, a resist pattern of satisfactory intrasurface uniformity can be formed, which contributes to the improvement of the yield of products.

### BRIEF DESCRIPTION OF THE DRAWINGS

FIG. 1 is a perspective view showing the internal structure of a heating device in a preferred embodiment according to the present invention;

FIG. 2 is a longitudinal sectional view of the heating device shown in FIG. 1;

FIG. 3 is a perspective view of a wafer carrying mechanism;

FIG. 4 is a longitudinal sectional view of assistance in explaining functions of a heating chamber of the heating device shown in FIG. 1;

FIGS. 5A to 5D are views of assistance in explaining functions of the heating device shown in FIG. 1;

FIG. 6 is a diagram showing a temperature control pattern, and actual variation of the respective temperatures of heating plates and a wafer carried into a heating chamber with time;

FIGS. 7A and 7B are diagrams showing the respective changing modes of the respective temperatures of a front and a rear end part of a wafer carried into the heating chamber;

FIGS. 8A and 8B are views of assistance in explaining temperature control patterns in modifications;

FIG. 9 is a diagram showing a temperature control pattern in another modification;

FIG. 10 is a plan view of a coating and developing system to which the heating device of the present invention is applied;

FIG. 11 is a perspective view of the coating and developing system shown in FIG. 10;

FIGS. 12A and 12B a graph and a diagram, respectively, showing an experiment conducted to confirm the effect of the temperature of heating plates on a wafer carried into a heating chamber;

FIG. 13 is a graph of assistance in explaining the effect of the heating plates on temperature difference between a front and a rear end part of a wafer carried into the heating chamber; and

FIGS. 14A and 14B are longitudinal sectional views of assistance in explaining functions of a conventional heating device.

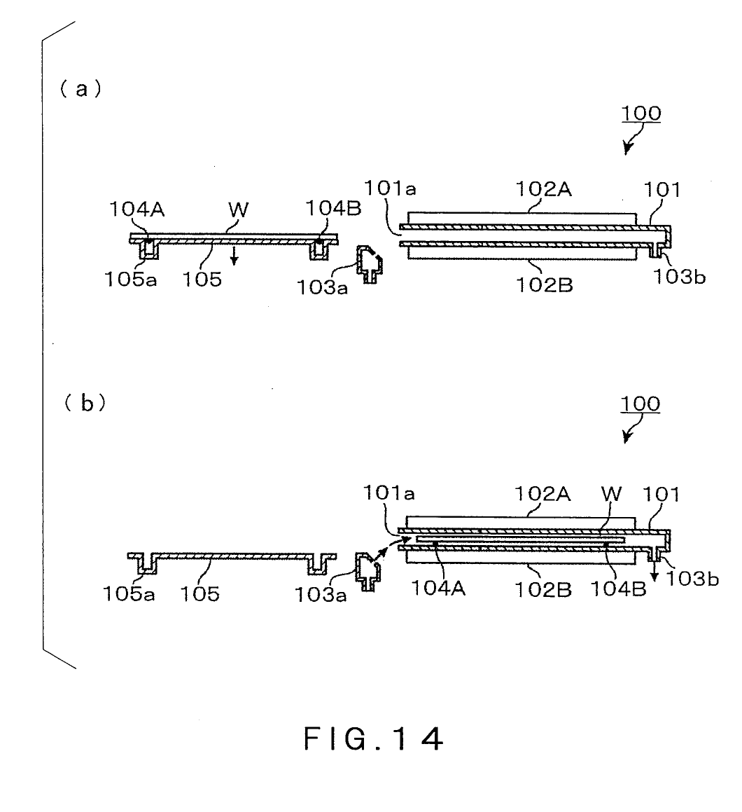

### DESCRIPTION OF THE PREFERRED EMBODIMENTS

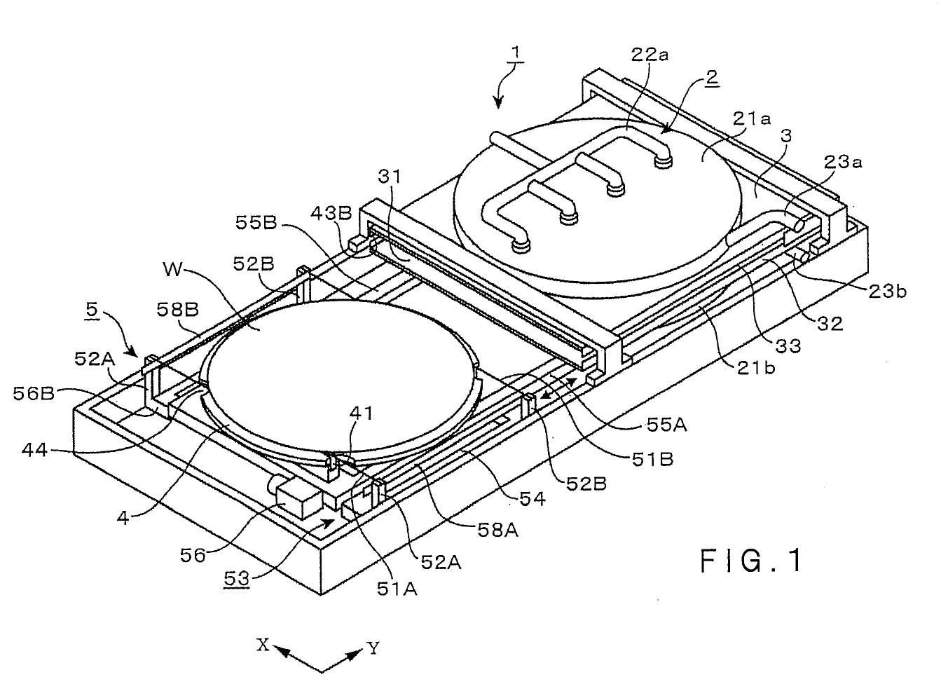

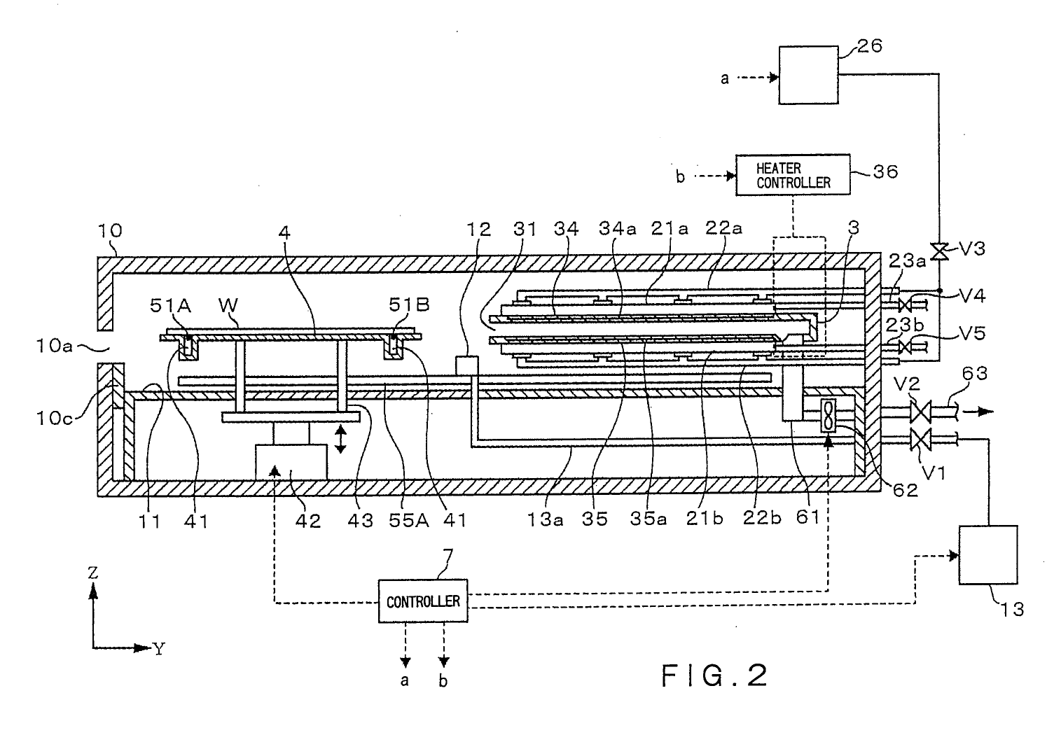

A heating device 1 in a preferred embodiment according to the present invention for carrying out the PEB process will be described by way of example with reference to FIGS. 1 to 6. FIG. 1 is a perspective view showing the internal structure of the heating device 1, and FIG. 2 is a longitudinal sectional view of the heating device 1.

As shown FIG. 2, the heating device 1 is contained in a processing vessel 10. The interior space of the processing vessel 10 is divided into an upper space and a lower space by a base 11. Referring to FIG. 1, disposed in the upper space in the processing vessel 10 are a flat heating chamber 3 for processing a wafer W by a heating process, a cooling plate 4 for supporting a wafer W carried into the processing vessel 10 thereon before the wafer W is processed by the heating process and after the wafer W has been processed by the heating process, and for cooling the wafer W after the wafer W has been processed by the heating process, and a carrying mechanism 5 for carrying a wafer W between the cooling plate 4 and the heating chamber 3. In FIG. 2, indicated at 10c is a shutter for closing an entrance opening 10a.

The cooling plate 4 is a substantially circular disk of aluminum or the like having a diameter approximately equal to that of a 12 in. diameter wafer W. The cooling plate 4 excluding parts in which grooves, which will be described later, are formed has a thickness of about 4 mm. The cooling plate 4 is provided in its back surface with a cooling mechanism, not shown, using temperature-controlled water. The cooling plate 4 is capable of roughly cooling a wafer W placed thereon. The cooling plate 4 is disposed at a waiting position at which a wafer W is held before the same is carried into the heating chamber 3.

The carrying mechanism 5 includes a plurality of wires 51A and 51B, for supporting and carrying a wafer W, wire holding members 52A and 52B for holding the wires 51A and 51B, and a moving mechanism 53 for moving the wire holding members 52A and 52B. The two wires 51A and 51B are extended in a direction, namely, in an X-direction in FIGS. 1 and 2, intersecting a carrying direction, namely, a Y-direction in FIGS. 1 and 2, in which a wafer W is carried. The wires 51A and 51B have opposite ends fixed to the wire holding members 52A and 52B and are extended between the wire holding members 52A and 52B. The wires 51A and 51B have, for example, a diameter of about 0.5 mm, and a length longer than the respective diameters of a wafer W and the cooling plate 4. Each of the wires 51A and 51B is made from heat-resistant materials, such as aramid filaments or silicon carbide filaments.

The wire holding members 52A are disposed opposite to each other with respect to the cooling plate 4, and the wire holding members 52B are disposed opposite to each other with respect to the cooling plate 4. The wires 51A and 51B are extended between the wire holding members 52A and between the wire holding members 52B, respectively. The wire holding members 52A and 52B are moved by the moving mechanism 53 to carry a wafer W between a position above the cooling plate 4 and a position in the heating chamber 3. Positions of the wires 51a and 51B on the side of the cooling plate 4 will be referred to as home positions.

The construction of the moving mechanism 53 will be roughly described. Base parts of the wire holding members 52A and 52B are fixed to, for example, common base members 54, respectively. A driving unit 56 drives the base members 54 to move the base members 54 along two guide rails 55A and 55B parallel to the carrying direction in which a wafer W is carried. Indicated at 58A and 58B are sealing plates for sealing gaps formed in the heating chamber to move the wires 51 therein to prevent air from leaking out from the heating chamber 3.

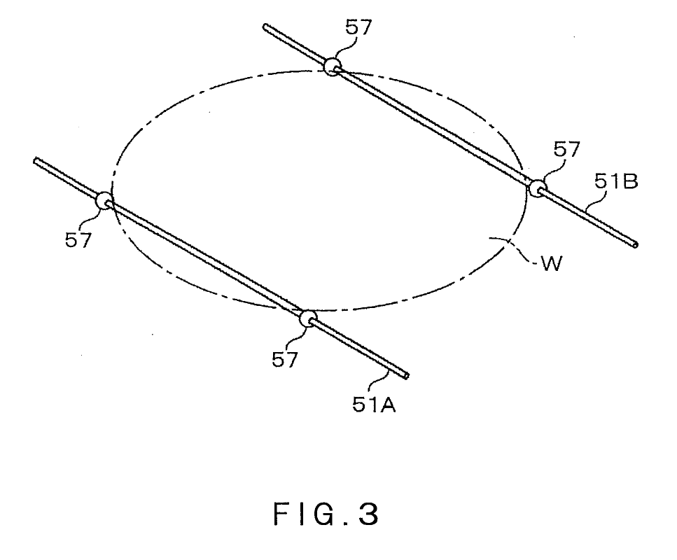

As shown in FIG. 3, the wires 51A and 51B are provided with beads 57 for positioning a wafer W on the wires 51A and 51B. For example, each of the wires 51A and 51B is provided with the two beads 57. The four beads 57 come into contact with the circumference of a wafer W to position the wafer W on the wires 51A and 51B and to prevent the dislocation of the wafer W while the wafer W is being carried. In the drawings excluding FIG. 3, the beads 57 are not shown for the sake of convenience.

Referring to FIGS. 1 and 2, the cooling plate 4 is provided with grooves 41, and the wires 51a and 51B are extended through the grooves 41, respectively. The grooves 41 are extended at positions corresponding to the respective home positions of the wires 51A and 51B so as to intersect the carrying direction in which a wafer W is carried. The grooves 41 are formed in a width sufficient to receive the beads 57 attached to the wires 51.

As shown in FIG. 2, a lifting mechanism 42 for vertically moving the cooling plate 4 is disposed under the base 11 lying under the cooling plate 4. The lifting mechanism 42 includes, for example, a plurality of support pins 43. The lifting mechanism 42 lifts up the support pins 43 so as to project vertically upward through openings formed in the base 11.

The lifting mechanism 42 moves the cooling plate 42 vertically relative to the wires 51A and 51B to receive the wires 51A and 51B in the grooves 41 or to let the wires 51 extend outside the grooves 41. Thus a wafer W is transferred between the wires 51A and 51B, and the cooling plate 4. Indicated at 44 in FIG. 1 are notches formed in the cooling plate 4 to enable support members projecting from the inside edge of a U-shaped arm included in a wafer carrying mechanism to move between the upper and the lower side of the cooling plate 4 without interfering with the cooling plate 4.

The construction of the heating chamber 3 will be described. The heating chamber 3 is provided in its front end wall facing the cooling plate 4 with an opening 31 through which a wafer W is carried into and carried out of the heating chamber 3. The opening 31 has a width, namely, a vertical dimension, of for example, 6 mm. The heating chamber 3 has an interior space greater than a wafer W. As shown in FIG. 2, the heating chamber 3 is made of a heat-conducting material, such as aluminum (Al) or a stainless steel sheet of about 3 mm in thickness. The heating chamber 3 has a U-shaped longitudinal section. As shown in FIG. 1, slots 33 of, for example, about 3 mm in width are formed in the side walls 32 on the sides of the opposite ends of the opening 31, respectively. The wires 51A and 51B extended between the wire holding members 52A and 52B can move through the slots 33.

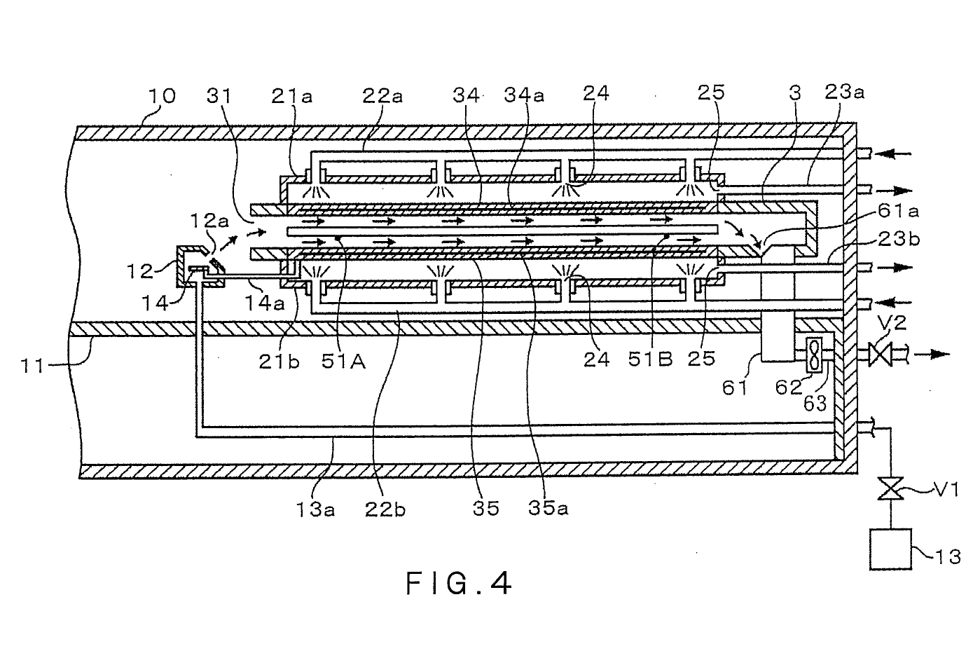

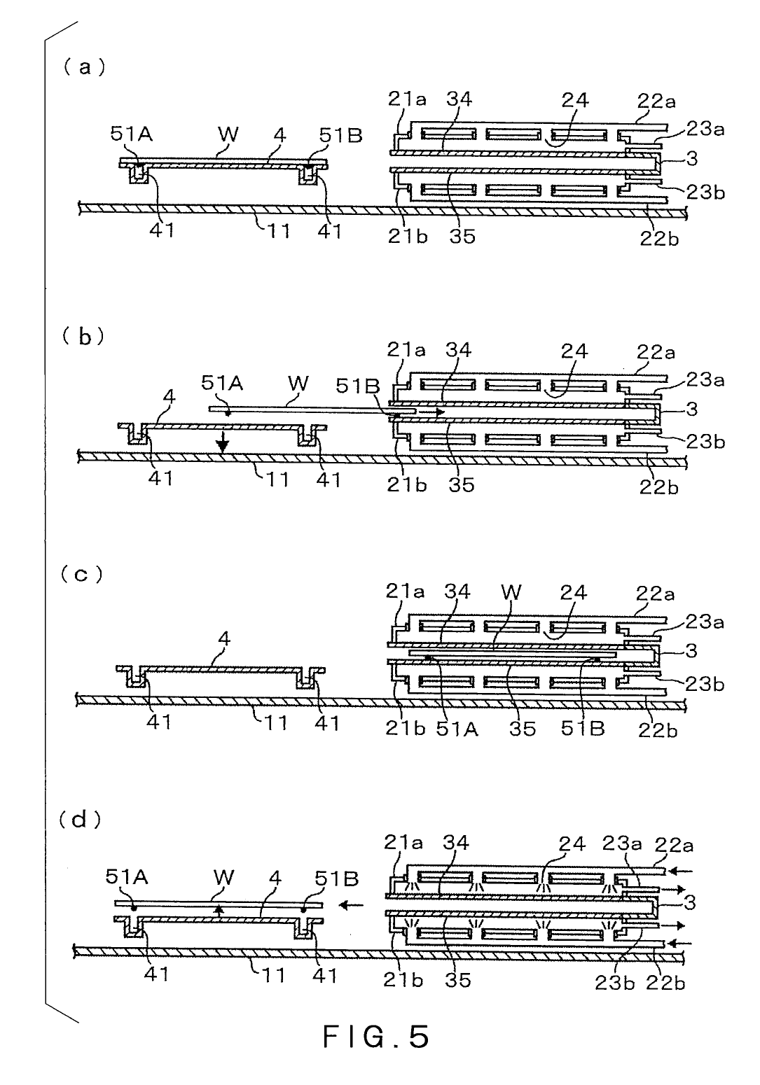

As shown in FIG. 4, heating plates 34 and 35 of aluminum nitride (AIN) or silicon carbide (SiC) are disposed contiguously with the upper and the lower wall, respectively, of the heating chamber 3 to heat the interior of the heating chamber 3. The heating plates 34 and 35 have the shape of a circular disk of a size substantially equal to that of a wafer W. Each of the heating plates 34 and 35 is a thin carbon plate of, for example, about 2 mm in thickness having a small heat capacity, a high thermal conductivity of 200 W/mK and a density of 1.9 g/cm³. The heating plates 34 and 35 are provided internally with heating elements 34a and 35a, such as resistance heating elements, respectively. The heating elements 34a and 35a are embedded in the heating plates 34 and 35, respectively, and are connected to a heater controller 36. The temperatures of the heating elements 34a and 35a, namely, the resistance heating elements, can be changed by changing power supplied to the heating elements 34a and 35a. In FIGS. 2 and 5, the heating plates 34 and 35 are shown integrally with the heating chamber 3 for the sake of convenience.

As shown in FIG. 2, a gas blowing duct 12 is disposed at a position corresponding to a part of the base 11 on the front side of the heating chamber 3, and an exhaust duct 61 is disposed at a position corresponding to a part of the base 11 in the depth of the heating chamber 3. As shown in FIG. 4, the gas blowing duct 12 has an inclined wall facing the opening 31 of the heating chamber 3. The inclined wall is provided with, for example, a plurality of small discharge openings 12a. The discharge openings 12a are arranged at specific intervals along the width of the processing vessel 10 parallel to the X-direction in FIG. 1. The length of a range in which the discharge openings 12a are arranged is substantially equal to the diameter of a wafer W. As shown in FIG. 4, a heat-conducting plate 14 is placed inside the gas blowing duct 12 and is connected to the heating plate 35 by a heat pipe 14a. A gas heated by the heat-conducting plate 14 at a temperature equal to a temperature at which the surface of a wafer W is to be heated can be blown out.

The gas blowing duct 12 is connected to a gas source 13 placed, for example, outside the processing vessel 10 by a gas supply pipe 13a provided with a valve V1. The gas source 13 stores an inert gas, such as nitrogen gas, as a clean purging gas. The exhaust duct 61 is disposed opposite to the gas blowing duct 12 with respect to the lower heating plate 35 contiguous with the lower wall of the heating chamber 3. The exhaust duct 61 has an inclined wall facing the heating chamber 3. The inclined wall is provided with, for example, a plurality of small suction openings 61a. The suction openings 61a are arranged at specific intervals along the width of the heating chamber 3. The length of the exhaust duct 61 is substantially equal to the diameter of a wafer W. The exhaust duct 61 is connected to, for example, an exhaust line of a plant by an exhaust pipe 63 provided with a fan 62 and a valve V2. Suction rate at which the exhaust duct 61 sucks the atmosphere is regulated by regulating the operating speed of the fan 62 and the opening of the valve V2.

The cooling device 1 in this embodiment is provided with a cooling mechanism 2. The cooling mechanism 2 cools the heating plates 34 and 35 in a forced cooling mode after the completion of a heating process for heating a wafer W. As shown in FIG. 2, the cooling mechanism 2 includes cooling chambers 21a and 21b formed contiguously with the top and the bottom wall, respectively, of the heating chamber 3, a coolant supply pipes 22a and 22b, and coolant discharge pipes 23a and 23b. A coolant, such as air of a room temperature, is supplied through the coolant supply pipes 22a and 22b into the cooling chambers 21a and 21b. The coolant supplied into the cooling chambers 21a and 21b is discharged through the coolant discharge pipes 23a and 23b.

Referring to FIGS. 1 and 4, each of the cooling chambers 21a and 21b is formed in a flat cylindrical shape of a diameter approximately equal to the diameter of a wafer W, and defines a hollow of about 3 mm in height. The cooling chambers 21a and 21b are attached to the heating chamber 3 so as to cover the top heating plate 34 and the bottom heating plate 35, respectively. The cooling chambers 21a and 21b are substantially the same in construction, only the top cooling chamber 21a will be described.

As shown in FIG. 4, the top wall of the cooling chamber 21a facing the heating plate 34 is provided with a plurality of supply openings 24. As shown in FIG. 2, the supply openings 24 are connected to a coolant source 26, such as a compressor for supplying dry air, by a coolant supply pipe 22a provided with a valve V3. The coolant supplied from the coolant source 26 into the cooling chamber 21a comes into contact with the heating plate 34 for the forced cooling of the heating plate 34. As shown in FIG. 4, a discharge opening 25 is formed in an end wall of the cooling chamber 21a. The coolant is discharged outside through the coolant discharge pipe 23a connected to the discharge opening 25 an exhaust system of a plant. Discharge rate at which the coolant is discharged is regulated by valves V5 and B6.

As shown in FIG. 2, the heating device 1 is provided with a controller 7 including, for example, a computer. The controller 7 is capable of controlling the operations of the lifting mechanism 42, the gas source 13, the coolant source 26 and the heater controller 36. To time a carrying operation for carrying a wafer W, operations for starting and stopping supplying the coolant into the cooling chambers 21a and 21b, the controller 7 reads a program specifying process parameters and processing procedures from a storage medium, not shown, and controls the components according to the program. The storage medium is, for example, a hard disk, a compact disk, a magnetooptical disk or a memory card.

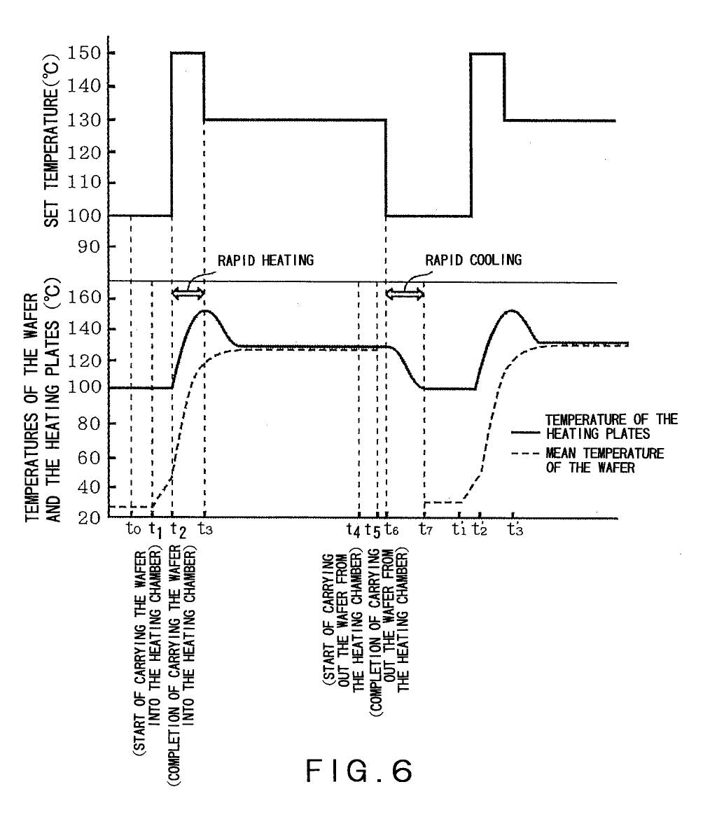

Operations of the heating device 1 in this embodiment will be described with reference to FIGS. 4 to 6. FIGS. 5A to 5D are views of assistance in explaining positions of a wafer W before and after the wafer W is carried into the heating chamber 3, and operations of the heating device 1, and FIG. 6 is a diagram of assistance in explaining set temperatures for the heating elements 34a and 35a, and the temperatures of the heating plates 34 and 35, and a wafer W carried into the heating chamber 3. In FIGS. 5A to 5D and 6, the gas blowing duct 12 and the exhaust duct 61 are mitted.

For example, a wafer W is carried by a wafer carrying mechanism, not shown, provided with a U-shaped carrying member to and transferred to the cooling plate 4 at the waiting position as shown in FIG. 5A. The wafer W is processed by a PEB process at, for example, 130° C. At a time point to before the wafer W is carried into the heating chamber 3, the heating elements 34a and 35a are heated at a temperature lower than the processing temperature, such as 100° C., to heat the heating plates 34 and 35, and the interior of the heating chamber 3 at the same temperature lower than the processing temperature.

Then, as shown in FIG. 5B, the cooling plate 4 is lowered to support the wafer W on the wires 51A and 51B, and the wires 51A and 51B are moved to carry the wafer W into the heating chamber. The front end of the wafer W enters the heating chamber first. The wafer W is carried in a substantially horizontal position into the flat heating chamber 3 through the side entrance 31. There is a time difference in the range of 1 to 3 s between time t₁ the front end of the wafer W is inserted into the heating chamber 3, namely, carrying start time, and time t₂ the rear end of the wafer W is inserted into the heating chamber 3, namely, carrying completion time. Since the front and the rear end of the wafer W are inserted into the heating chamber 3 at different times t₁ and t₂, respectively, a front end part and a rear end part of the wafer W are heated for different times, respectively, in the heating chamber 3. At the completion of carrying the wafer W into the heating chamber 3, a temperature distribution in which the temperature of the front end part of the wafer W is high and that of the rear end part of the wafer W is low is created in the wafer W.

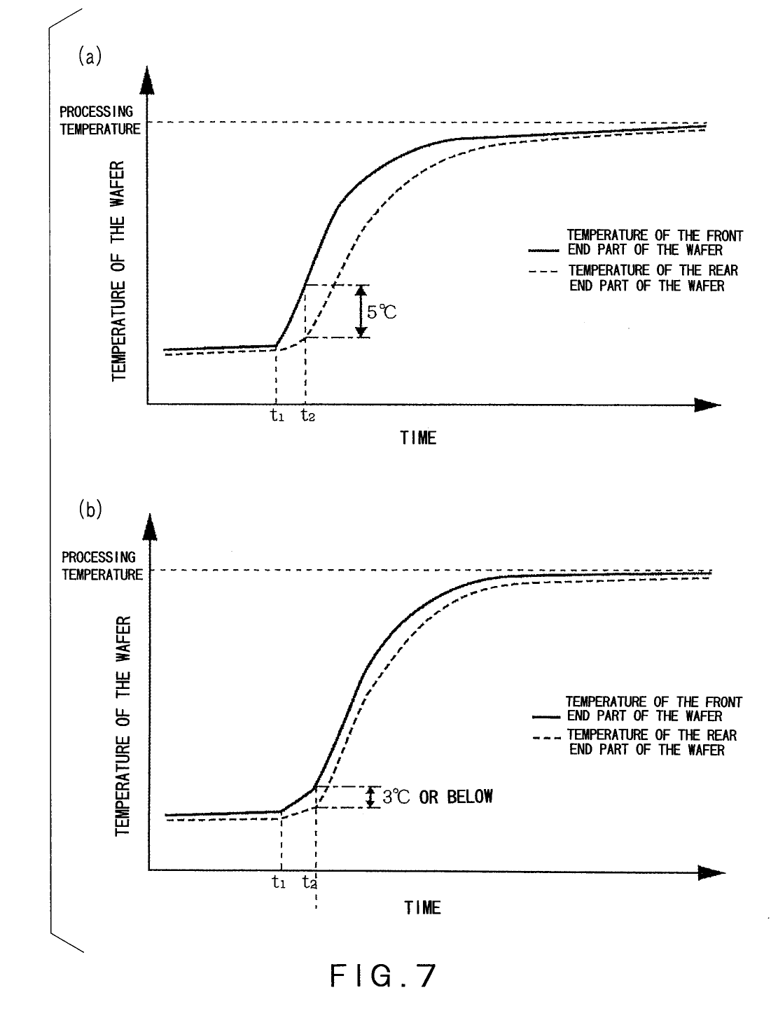

Principle of creation of such a temperature distribution will be explained. FIG. 7A is a diagram showing the respective changing modes of the respective temperatures of a front and a rear end part of a wafer carried into a conventional heating chamber not provided with the cooling mechanism 2. In FIG. 7A, a continuous line indicates the variation of the front end part of the wafer W and a broken line indicates the variation of the temperature of the rear end part of the wafer W. When the front end part of the wafer w is inserted into the heating chamber heated at a processing temperature, the temperature of the front end part rises along the continuous line to the processing temperature as shown in FIG. 7A. The rear end part of the wafer W is heated gradually by heat transferred thereto from the front end part by conduction. However, there is a big temperature difference of 3° C. or above, for example, 5° C., at the time the rear end of the wafer W is inserted into the heating chamber because the heating plates and the interior of the heating chamber are heated beforehand at the processing temperature. Consequently, a wide temperature distribution remains for some time even if the rear end part is heated at the same rate as the front end part. Such a heating mode brings about an irregular resist pattern.

In this embodiment, the heating elements 34a and 35a are heated at a low set temperature. Therefore, the quantity of heat absorbed by the wafer W carried into the heating chamber 3 in a unit time is smaller than that absorbed by the wafer W in a unit time when the heating chamber 3 is maintained at the processing temperature. Consequently, the temperature difference between the front and the rear end part due to the difference between the time the front end part is inserted into the heating chamber 3 and the time the rear end part is inserted into the heating chamber is small. As mentioned above, this embodiment keeps the heating plates 34 and 35, and the interior of the heating chamber 3 at 100° C. lower than the processing temperature. Consequently, the temperature difference between the front and the rear end part of the wafer W at the time t₂ the carrying operation for carrying the wafer W into the heating chamber 3 is completed can be limited to 3° C. or below. Since the range of the temperature distribution in the wafer W at the time the rear end of the wafer W is inserted into the heating chamber 3 is narrow, the temperature of the wafer W rises in a mode as shown in FIG. 7B, in which the temperature difference between the front and the rear end part of the wafer W is small. Thus the irregularity of a resist pattern formed on the wafer W can be reduced.

Since the heating elements 34a and 35a are heated at the low set temperature at the start of carrying a wafer W into the heating chamber 3, the heating plates 34 and 25 needs to be heated to the processing temperature by a temperature raising process after the completion of carrying a wafer W into the heating chamber 3. Consequently, in most cases, a long time is needed for completing the temperature raising process after the completion of carrying a wafer W into the heating chamber 3. The heating device 1 in this embodiment executes a rapid heating process for rapidly raising the temperature of the heating plates 34 and 35 after the completion of carrying a wafer W into the heating chamber to reduce time necessary for completing the temperature raising process.

The rapid heating process will be described. A wafer W carried into the heating chamber 3 is supported on the wires 51A and 51B at a heat-processing position corresponding to the heating plates 34 and 35 so as to be spaced apart from the heating plates 34 and 35 as shown in FIG. 5C. the valve V1 of the heating device 1 is opened to blow the purging gas heated at the same temperature as the interior of the heating chamber 3 through the gas blowing duct 12 into the heating chamber 3 and, at the same time, the valve V2 is opened and the fan 62 is actuated to discharge the gas from the heating chamber 3. Consequently, unidirectional flows of the gas are generated over and under the wafer W as indicated by the arrows in FIG. 4. Thus the wafer W held at a height at which the wafer W carried into the heating chamber is placed is processed by the heating process using heat radiated by the heating plates 34 and 35, and heat transferred to the wafer W by the convection of the gas.

In the meantime, as shown in FIG. 6, the heating device 1 starts raining the temperature of the heating elements 34a and 35a to a temperature higher than the processing temperature upon the completion of carrying the wafer W into the heating chamber 3, and maintains this condition for a predetermined time. Consequently, the temperatures of the heating plates 34 and 35 and the interior of the heating chamber 3 are raised rapidly. Thus the temperature of the wafer can be rapidly raised, and the temperature raising process can be completed in a reduced time.

A set temperature for the heating elements 34a and 35a during the rapid heating process is, for example 150° C., and the heating elements 34a and 35a are kept at this set temperature, for example, for 15 s. A heat-processing time between the time t₂ carrying the wafer W into the heating chamber 3 is completed and the time t₄ carrying the wafer W processed by the heating process out of the heating chamber 3 is started can be reduced to a time approximately equal to a time needed by the conventional heating process in which the temperature of the interior of the heating chamber 3 is not varied.

Subsequently, the heating device 1 terminates the rapid heating process at time t₃ a predetermined time after the time t₃ when the rapid heating process is started, and changes the set temperature for the heating elements 34a and 35a for the processing temperature as shown in FIG. 6. The heating elements 34a and 35a are kept at the processing temperature for a predetermined time to process the wafer W by the heating process. A time between the times t₂ and t₃ are determined such that the wafer W can be heated to a temperature nearly equal to the processing temperature in that time. Thus the chemically amplified resist film formed on the wafer W and processed by the exposure process is heated by the PEB process including the foregoing steps.

At time t₄ when the heating process for heating the wafer W is to be terminated, the supply of the purging gas and discharge of the gas are stopped, and then, the procedure for carrying the wafer W into the heating chamber 3 is reversed to carry out the wafer W from the heating chamber. Then, as shown in FIG. 5D, the processed wafer W is transferred from the wires 51A and 51B to the cooling plate 4, the wafer W is cooled roughly to stop the acid reaction in the resist film. Then, the wafer W is transferred from the cooling plate 4 to the external carrying mechanism, and the wafer W is carried out of the processing vessel 10 to complete the heating process by the heating device 1. Although the supply of the purging gas is started and stopped when the wafer W is carried into and when the wafer W is carried out of the heating chamber 3, respectively, in the foregoing mode of operation of the heating device 1, the purging gas may be continuously supplied while the heating device 1 is in operation.

While the wafer W processed by the heating process is being cooled and carried out of the processing vessel 10, the heating plates 34 and 35 in the heating chamber 3 are cooled to prepare for receiving a succeeding wafer W in the heating chamber 3. A rapid cooling process is executed at time t₆ after the time t₅ of completion of carrying out the preceding wafer W from the heating chamber 3 to lower the set temperature for the heating elements 34a and 35a to 100° C. at which the heating elements 34a and 35a are to be heated at the reception of the succeeding wafer W in the heating chamber 3. The rapid cooling process may be started at the time t₄ when the heating process for heating the wafer W is terminated.

It is possible that the temperatures of the heating plates 34 and 35, and the interior of the heating chamber 3 do not drop to 100° C. before time when the succeeding wafer W can be carried into the heating chamber if those temperatures can be lowered at a low rate only by changing the set temperature. The heating device 1 in this embodiment rapidly cools the heating plates 34 and 35, and the interior of the heating chamber 3 by the cooling mechanism 2 to eliminate a waiting time.

Operations of the cooling mechanism 2 will be described. The valves V3 to V5 are opened at the time t₅ (FIG. 6) the operation for carrying out the wafer W from the heating chamber is completed to start supplying the coolant from the coolant source 26 into the cooling chambers 21a and 21b as shown in FIGS. 4 and 5D. Consequently, the heating plates 34 and 35, and the interior of the heating chamber 3 are cooled rapidly, and the rapid cooling process can be completed before the succeeding wafer W is carried into the heating chamber 3. The supply of the coolant is stopped at time t₇ the rapid cooling process is completed to prepare for receiving the succeeding wafer W. A cycle of the processes illustrated in FIGS. 5A to 5D is repeated to process a plurality of wafers W by the PEB process.

The heating device 1 has the following effects. Since the interior of the heating chamber 3 is cooled to the temperature lower than the processing temperature before a wafer W is carried in a horizontal position through the side opening 31 into the flat heating chamber 3, the temperature difference between the front and the rear end part of the wafer W is small as compared with that when the interior of the heating chamber 3 is not cooled to the temperature lower than the processing temperature. Consequently, the wafer W can be heated in intrasurface uniformity by, for example. The PEB process, a resist pattern satisfactory in intrasurface uniformity can be formed, which contributes to the improvement of the yield of products.

Rapid heating for heating a wafer W carried into the heating chamber 3 at the processing temperature, and rapid cooling for cooling the interior of the heating chamber 3 after completing the heating process for heating the wafer W can reduce time necessary to achieve the temperature raising process and the temperature lowering process. Since the heating process for heating a wafer W can be completed in a time approximately equal to a time in which the conventional heating method that does not change the temperature of the interior of the heating chamber 3 completes the heating process. Thus the reduction of throughput due to the addition of additional processes to the heating method can be prevented.

When the heating plates 34 and 35 are thin carbon plates having a small heat capacity, the temperature of the heating plates 34 and 34 can satisfactorily follow up temperature changes for rapid heating and rapid cooling. The coolant used by the cooling mechanism 2 is not limited to a gas, such as air, and the coolant may be a liquid having a large heat capacity, such as water. The cooling means is not limited to the foregoing cooling mechanism 2 that brings the coolant into direct contact with the heating plates 34 and 35. The heating means may be Peltier elements embedded in the heating plates 34 and 35. A thick plate having a large heat capacity, such as a stainless steel plate, of a diameter approximately equal to that of a wafer W may be held at a position in the heating device 1 so that the thick plate may not interfere with a wafer W when the wafer W is carried into the heating chamber 3, and thick plate may be inserted into the heating chamber 3 as a heat absorber to cool rapidly the interior of the heating chamber 3 and the heating plates 24 and 35.

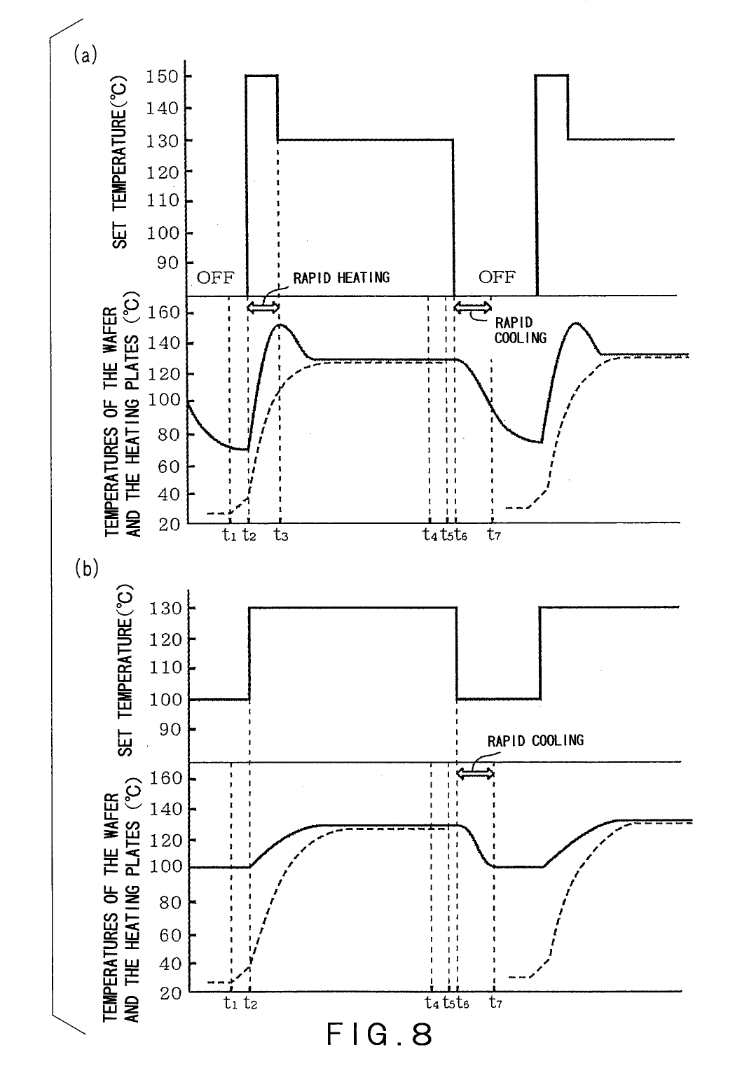

A sequential temperature control pattern in which the temperature of the heating plates 34 and 34 is controlled is not limited to the temperature control pattern described in connection with FIG. 6. For example, supply of power to the heating elements 34a and 35a may be interrupted during a period between the completion of the heating process and the insertion of a succeeding wafer W into the heating chamber 3 as shown in FIG. 8A to save energy. When a sufficiently long time is available for processing a wafer W and wafers W can be carried into the heating chamber 3 at long intervals, the rapid heating process may be omitted as shown in FIG. 8B or the rapid cooling process may be omitted. The temperature of only either of the two heating plates 34 and 35 may be rapidly raised and may be rapidly lowered.

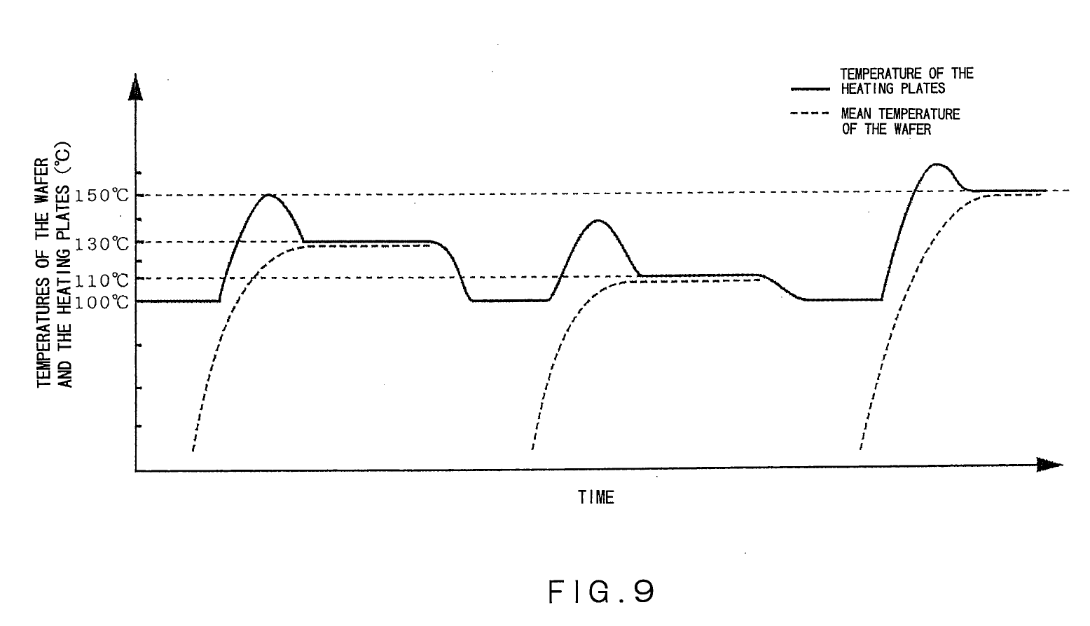

The temperature of the heating plates 34 and 35 of the heating device 1 in this embodiment can be chanted while the heating device 1 is in operation. Therefore, for example, when the lot of the products or the type of the resist is changed, and the processing temperature for processing wafers W by the heating process needs to be changed through the fine adjustment of operating conditions as shown in FIG. 9, the processing temperature can be changed without requiring special adjustment and without interrupting the operation of the heating device 1.

The temperature of the surface of a wafer W carried into the heating chamber 3 may be measured by a thermometer, and the termination of rapid heating may be timed on the basis of a measured temperature measured by the thermometer.

In the heating device 1 in this embodiment, the wafer carrying means are the wires 51A and 51B extended in the direction intersecting the carrying passage. For example, the carrying means may include pulleys disposed near the opposite ends of the carrying passage, and a plurality of wires extended parallel to the carrying passage and wound round the pulleys to carry a wafer W. When this carrying means is employed, grooves are formed in the cooling plate 4 along the wires parallel to the carrying direction.

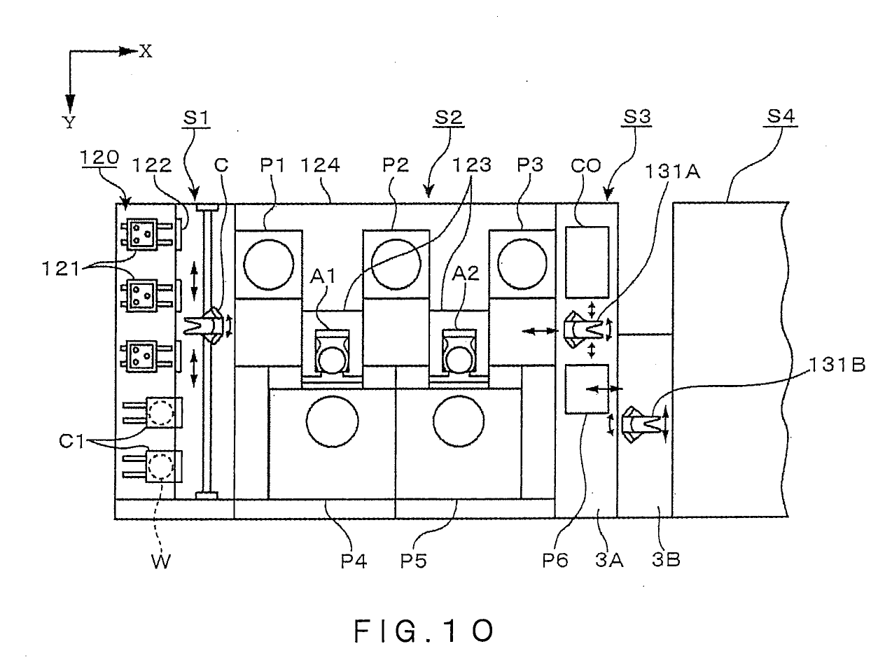

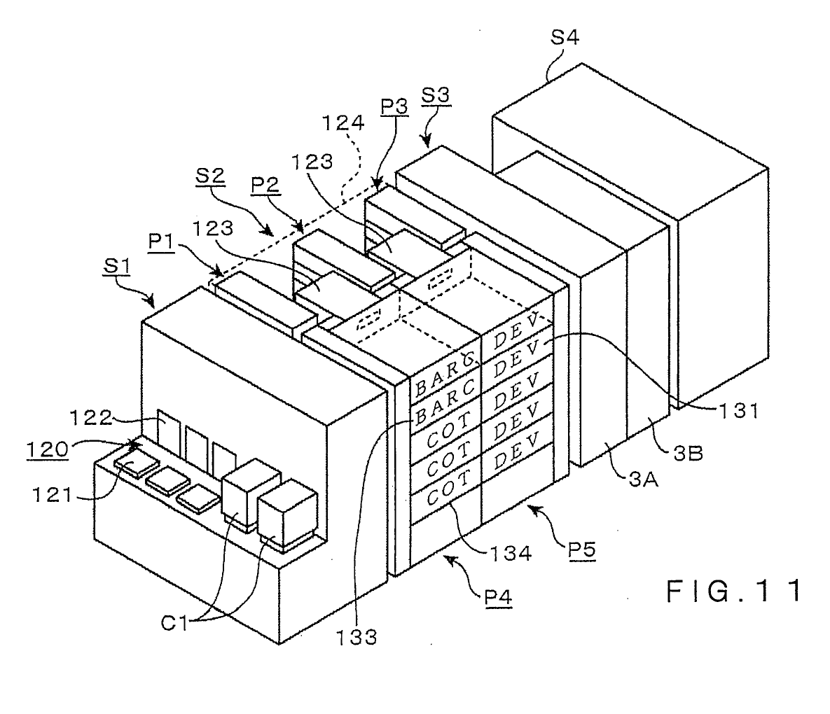

A coating and developing system provided with the heating device 1 will be described. FIGS. 10 and 11 are a plan view and a perspective view, respectively, of the coating and developing system. A carrier block S1 has a carrier station 120, for receiving a carrier C1 containing, for example, thirteen wafers W, provided with carrier tables 121 on which carriers C1 are placed, closable openings 122 closed by doors and formed in a wall on the front side of the carrier station 120, and a transfer arm C for taking out a wafer W from the carrier C1 through the closable opening 122.

A processing block S2 surrounded by a box 124 is joined to the inner end of the carrier block S1. The processing block 52 includes shelf units P1, P2 and P3 each formed by stacking up heating and cooling modules in layers, wet-processing units P4 and P5, and main arms A1 and A2, namely, carrying means. The shelf units P1, P2 and P3, the wet-processing units P4 and P5, and the main arms A1 and A2 are arranged alternately. The main arms A1 and A2 carry wafers W from one to another of those modules. Each of the main arms A1 and A2 is disposed in a space 123 surrounded by the side walls of the adjacent ones of the shelf units P1, P2 and P3, the inner side wall of the corresponding one of the wet-processing units P4 and P5, and a rear wall extending between the adjacent ones of the shelf units P1, P2 and P3.

The shelf units P1, P2 and P3 are formed by stacking in layers pretreatment modules for pretreating a wafer W before the wafer W is processed by the wet-processing units P4 and P5, and posttreatment units for posttreating a wafer W processed by the wet-processing unit P4 and P5. The stacked modules include heating modules (PABs and PEBs), namely, the heating devices of the present invention, for processing a wafer W by a baking process, and cooling modules for cooling a wafer W.

The wet-processing units P4 and P5 are mounted on chemical solution storage units for storing a resist solution and a developer. The wet-processing unit P4 is formed by stacking lower antireflection film forming modules 133 and resist solution applying modules 134 in, for example, five layers. The wet-processing unit P5 is formed by stacking developing modules 131 in, for example, five layers.

An interface block S3 has a first carrying chamber 3A and a second carrying chamber 3B longitudinally arranged between the processing block S2 and an exposure system S4. Wafer carrying mechanisms 131A and 131B are installed in the first carrying chamber 3A and the second carrying chamber 3B, respectively. The wafer carrying mechanisms 131A and 131B are vertically and horizontally movable and turnable about a vertical axis.

A shelf unit P6 and a buffer cassette CO are installed in the first carrying chamber 3A. The shelf unit P6 is formed by stacking transfer stages (TRS) and precision temperature adjusting modules. A wafer is transferred between the wafer carrying mechanism 131A and 131B through the transfer stage. The precision temperature adjusting module is provided with a cooling plate for adjusting the temperature of a wafer W to a desired temperature before sending the wafer W to the exposure system S4.

The flow of a wafer W in the coating and developing system will be described. A carrier C1 containing wafers W is delivered from an external system to the carrier block S1. Then, a wafer W is carried along a route passing the transfer arm C, the transfer stage (TRS) of the shelf unit P1, the carrying mechanism A1, the lower antireflection film forming module (BARC) 133, the carrying mechanism A1, the heating device 1 (PAB), the carrying mechanism A1, the cooling module, the carrying mechanism A1, the resist solution application module (COT) 134, the carrying mechanism A1, the heating device 1 (PAB), the carrying mechanism A1, the cooling module, the carrying mechanism A2, the transfer stage (TRS) of the shelf unit P3, the wafer carrying mechanism 131A, the transfer stage (TRS) of the shelf unit P6, the temperature adjusting module of the shelf unit P6, the wafer carrying mechanism 131B, and the exposure system S4.

The wafer W processed by an exposure process is carried along a route passing the wafer carrying mechanism 131B, the transfer stage (TRS) of the shelf unit P6, the wafer carrying mechanism 131A, the transfer stage (TRS) of the shelf unit P3, the heating device 1 (PEB) of the shelf unit P3, the carrying mechanism A2, the developing module 131, the carrying mechanism A1, the transfer stage (TRS) of the shelf unit P1, and the transfer arm C. Then, the transfer arm C returns the processed wafer W into the carrier C1 to terminate the coating and developing process.

### EXAMPLES

### Experiment 1

A wafer W was processed by a heating process by a heating device 1 substantially the same as the heating device 1 described above with reference to FIGS. 1 to 4 to verify the mean temperature of the wafer W and the change of the temperature difference between a front and a rear end part of the wafer with time. In Experiment 1, A 12 in. diameter wafer W was carried into the heating chamber 3 heated at 130° C. by the heating plates 34 and 35 at a carrying speed of 30 cm/s. Temperatures varying with time were measured.

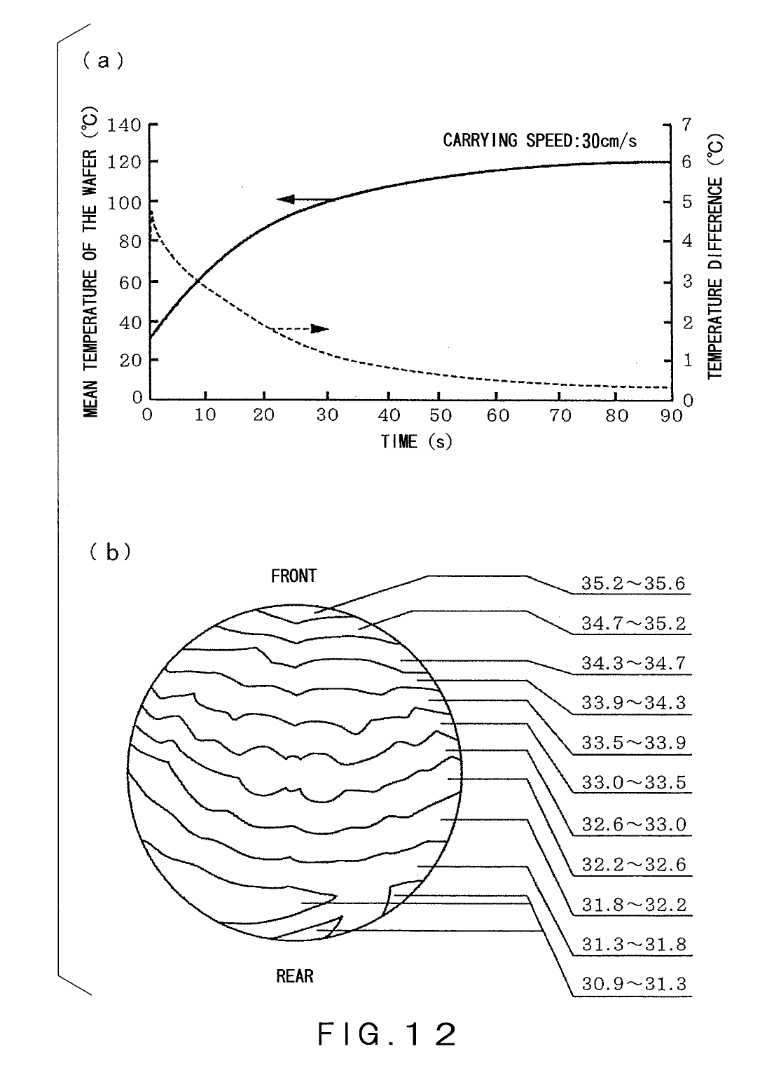

Results of Experiment 1 are shown in FIG. 12A, in which a continuous line indicates the variation of the mean temperature of the wafer W with time, and a broken line indicates the variation of the temperature difference between the front and the rear end part of the wafer W with time. It is known from FIG. 12A that the mean temperature of the wafer W rose gradually with heating time, reached a fixed temperature of about 120° C. and stopped rising beyond about 120° C. The temperature difference between the front and the rear end part of the wafer W increased sharply near to about 5° C. immediately after the wafer W had been carried into the heating chamber 3.

FIG. 12B shows a temperature distribution created in the wafer W at the time the temperature difference increased sharply. In FIG. 12B, the front and the rear end of the wafer W with respect to a carrying direction toward the heating chamber 3 are on the upper and the lower side, respectively. The temperature distribution in the surface of the wafer W is represented by isothermal lines. The isothermal lines indicate temperatures at intervals of 0.4° C. Temperatures of areas each extending between the adjacent isothermal lines are in temperature ranges indicated on the right-hand side of FIG. 12B. It is known from the temperature distribution shown in FIG. 12B that a temperature distribution in which the temperature of the front end part of the wafer is high and the temperature of the rear end part of the wafer W is low is created in the surface of the wafer W carried into the heating chamber 3. The temperature difference between the front and the rear end part of the wafer decreases gradually with the elapse of the processing time as indicated by the broken line in FIG. 12A. However, the temperature difference did not decrease below 1° C. in about 35 s after the wafer W had been carried into the heating chamber 3.

### Experiment 2

A heating device 1 similar to that used for experiment 1 was used. The temperature of the heating plates 34 and 35 was changed, and the changes in the temperature difference between the front and the rear end part of the wafer W immediately after the wafer W had been carried into the heating chamber 3 were measured. Other conditions for Experiment 2 are the same as those for Experiment 1.

Temperature of the Heating Plates 34 and 35

Example: 105° C.

Comparative example 1: 115° C.

Comparative example 2: 130° C.

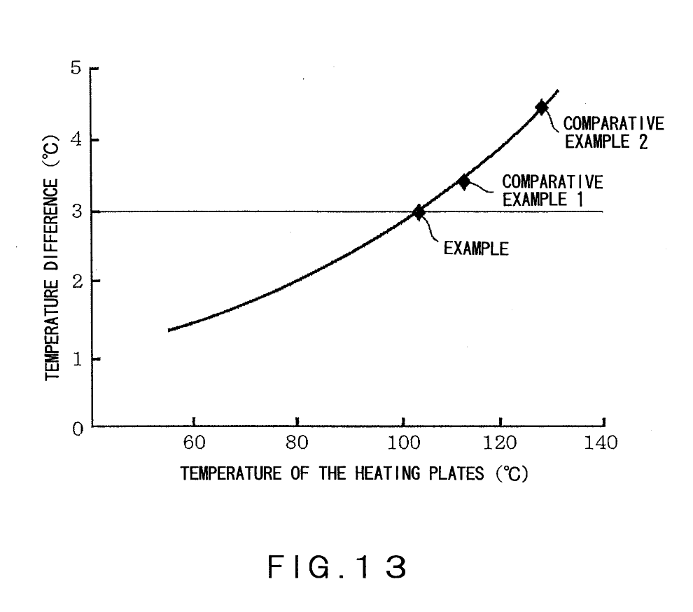

Results of Experiment 2 are shown in FIG. 13. FIG. 13 shows temperature differences between the front and the rear end part of the wafer W respectively corresponding to the temperatures of the heating plates 34 and 35, and an approximate curve formed by connecting the points of the temperature differences. Whereas the temperature difference between the front and the rear end part in Example was about 3° C., those in Comparative examples 1 and 2 were about 3.5° C. and 4.5° C., respectively. The inventors of the present invention recommend a desired temperature difference of 3° C. or below to form a resist pattern of lines having intrasurface uniform line width. It is known from the approximate curve shown in FIG. 13 that the temperature difference between the front and the rear end part of a wafer W immediately after the insertion of the wafer W into the heating chamber of the heating device 1 used in the foregoing experiment can be limited to 3° C. or below by heating the heating plates 34 and 35, and the interior of the heating chamber 3 at about 100° C. or below before carrying the wafer W into the heating chamber 3.

Although the invention has been described in its preferred embodiments with a certain degree of particularity, obviously many changes and variations are possible therein. It is therefore to be understood that the present invention may be practiced otherwise than as specifically described herein without departing from the scope and spirit thereof.

What is claimed is:

1. A heating device comprising:
a heating chamber contained in a processing vessel to process a substrate horizontally carried therein through a side opening by a heating process;
heating plates disposed so as to be opposite to the substrate carried into the heating chamber;
heating means for heating the heating plates;
cooling means for cooling the heating plates;
carrying means, for carrying the substrate between a waiting position adjacent to the side opening of the heating chamber, and a heating position corresponding to the heating plates, placed in the processing vessel; and
a control means for controlling the cooling means so as to lower the temperatures of the heating plates after the heating process for heating the substrate has been completed and before a succeeding substrate is carried into the heating chamber, and controlling the heating means so as to raise the respective temperatures of the heating plates to a processing temperature for the heating process after the succeeding substrate has been carried into the heating chamber.

2. The heating device according to claim 1, wherein the control means controls the heating means such that the heating plates are heated at a temperature higher than the processing temperature after the substrate has been carried into the heating chamber, and then the heating plates are maintained at the processing temperature.

3. The heating device according to claim 1, wherein the heating plates are made of carbon.

4. The heating device according to claim 3, wherein the substrate is subjected to a heating process at a position at a height in the heating chamber to which the substrate has been carried by the carrying means.

5. The heating device according to claim 4, wherein the carrying means are a plurality of wires.

6. The heating device according to claim 3, wherein the carrying means are a plurality of wires.

7. The heating device according to claim 2, wherein the substrate is subjected to a heating process at a position at a height in the heating chamber to which the substrate has been carried by the carrying means.

8. The heating device according to claim 2, wherein the carrying means are a plurality of wires.

9. The heating device according to claim 1, wherein the heating plates are made of carbon.

10. The heating device according to claim 9, wherein the substrate is subjected to a heating process at a position at a height in the heating chamber to which the substrate has been carried by the carrying means.

11. The heating device according to claim 10, wherein the carrying means are a plurality of wires.

12. The heating device according to claim 9, wherein the carrying means are a plurality of wires.

13. The heating device according to claim 1, wherein the substrate is subjected to a heating process at a position at a height in the heating chamber to which the substrate has been carried by the carrying means.

14. The heating device according to claim 13, wherein the carrying means are a plurality of wires.

15. The heating device according to claim 1, wherein the carrying means are a plurality of wires.

16. A heating method comprising:
a carrying step of horizontally carrying a substrate through a side opening of a heating chamber formed in a processing vessel into the heating chamber;
a heating step of heating the substrate carried into the heating chamber by heating plates;
a temperature lowering step of lowering the temperature of the heating plates after the heating process for processing the substrate has been completed and before a succeeding substrate is carried into the heating chamber; and
a temperature raising step of raising the temperature of the heating plates to a processing temperature after the succeeding substrate has been carried into the heating chamber.

17. The heating method according to claim 16 further comprising, between the carrying step and the heating step, a temperature controlling step of heating the heating plates to a temperature higher than the processing temperature, and then maintaining the heating plates at the processing temperature.

18. The heating method according to claim 17, wherein the heating step of heating the substrate is executed with the substrate held at a position at a height in the heating chamber to which the substrate has been carried.

19. The heating method according to claim 16, wherein the heating step of heating the substrate is executed with the substrate held at a position at a height in the heating chamber to which the substrate has been carried.

20. A storage medium storing a computer program to be executed by a heating device contained in a processing vessel, and including a heating chamber provided with a side opening through which a substrate is carried into the heating chamber, and a heating plate for heating the substrate from below the substrate;
wherein the computer program specifies the steps of one of the heating method set forth in claim 16.
